(19) United States
(12) Patent Application Publication
(10) Pub. No.: US 2012/0231656 A1
(43) Pub. Date: Sep. 13, 2012

(54) CONNECTOR FIXATION METAL FITTING AND CONNECTOR

(75) Inventor: Kazuaki TAKAO, Kawasaki (JP)

(73) Assignee: FUJITSU LIMITED, Kawasaki-shi (JP)

(21) Appl. No.: 13/355,595

(22) Filed: Jan. 23, 2012

(30) Foreign Application Priority Data
Mar. 8, 2011 (JP) 2011-050798

(51) Int. Cl. H01R 13/60; F16B 17/00

(52) U.S. Cl. 439/527; 24/591.1

(57) ABSTRACT

A connector fixation metal fitting includes: an attachment portion to be attached to a body of a connector; and an insertion piece to be inserted into an attachment hole formed in a board on which the connector is mounted, wherein the insertion piece includes two elastic pieces, the two elastic pieces are coupled together at their ends in the insertion direction of the insertion piece into the board and extend from the coupled portions in a direction opposite to the insertion direction so as to form free ends, and the free ends are bent in opposite directions in the plate-thickness direction.

### CROSS REFERENCE TO RELATED APPLICATION

This application is based upon and claims the benefit of priority of the prior Japanese Patent Application NO. 2011-050798 filed on Mar. 8, 2011, the entire contents of which are incorporated herein by reference.

### FIELD

The embodiments discussed herein are related to a connector fixation metal fitting and a connector.

### BACKGROUND

It is common to mount a connector on a board such as a printed circuit board and to connect with another electric circuit. In mounting a connector on a board, hitherto, a pin insertion method has been used in which contact pins are passed through through-holes of a board and are then soldered to the lower surface of the board. However, recently, due partly to the fact that electronic devices have been required to be smaller and thinner, a surface mounting method has been widely used in which contact pins are soldered directly to the upper surface of a board.

A connector mounted on a board (that is to say, a receptacle connector) is mated with a plug connector. Particularly in the case of a connector for external connection such as a VGA (Video Graphics Array) connector, a plug connector is frequently inserted into and extracted from the connector, and therefore the body of the connector is generally attached to a board using a fixation metal fitting so that the force at the time of insertion and extraction is not applied directly to the soldered contact pins.

Such a fixation metal fitting has locking pieces that are engaged with a board. The locking pieces are inserted into an attachment hole formed in a board and are then soldered to the lower surface of the board. The connector is automatically mounted on the board using a mounter together with other electronic components. The connector is placed in a temporarily fixed state on the board until all the electronic components have been mounted and soldered in the next process. If in this temporarily fixed state, the mounted connector is displaced from the attachment hole by vibration or some sort of external force, adjustment after soldering is needed. For this reason, the holding force of temporary fixation is required to be large.

The fixation metal fitting fixes the connector body to the board firmly. The fixation metal fitting is also required to temporarily fix the connector to the attachment hole and to hold the connector until the above-described soldering is performed. For this purpose, a technique is known in which so that a fixation metal fitting inserted into a board does not easily come off, the fixation metal fitting is engaged with an attachment hole.

For example, a structure of a fixation metal fitting is known that includes a pair of locking pieces formed of a plate-like spring material and spaced at a predetermined distance apart in the plate-width direction, and outward-bulging pressing portions provided at the distal ends of the locking pieces, wherein when the locking pieces are inserted into an attachment hole of a board, the pressing portions press the inner wall of the attachment hole in the plate-width of the locking piece direction by spring pressure and thereby hold the connector (Japanese Unexamined Utility Model Application Publication No. 02-012169).

A method is known in which a locking portion of a fixation metal fitting has such a structure that two downward-extending spring pieces bent in a V-shape in the plate-thickness direction of the spring piece, and when the spring pieces are inserted into an attachment hole of a board, the bent portions of the spring pieces press the inner wall of the attachment hole in the plate-thickness direction and thereby maintain temporary fixation (Japanese Unexamined Utility Model Application Publication No. 02-012169).

As described above, a connector for the surface mounting method is sometimes mounted on a board using a fixation metal fitting. This fixation metal fitting is fixed to a board, and it prevents the force applied at the time of insertion and extraction of a plug connector from being transmitted directly to soldered contact pins, and temporarily fixes the connector so that the connector is not displaced from or does not come off of the board until the connector has been mounted on and soldered to the board.

A connector mounted on a board is required to be space-saving owing to the reduction in size and thickness of electronic devices. A D-SUB connector is used as a connector for external connection in a notebook PC or the like. In this connector, the size of the side where a user inserts and extracts a plug connector (here referred to as “fitting side”) is the same as that of conventional connectors, but the size of the side located inside the housing of an electronic device where contact pins connected to a board are located (here referred to as “contact side”) is minimized to save space. The fitting side of the D-SUB connector is generally covered by a metal shell, and the size of the contact side is reduced to save space. Therefore, the weight of the fitting side of the connector is significantly larger than that of the contact side. Owing to the variation in the dimension of the attachment hole, sometimes the temporarily-fixed connector inclines to the fitting side, which is larger in weight, and contact pins are displaced upward from the board.

The above-described structure of the fixation metal fitting maintaining temporary fixation is not a big problem for temporary fixation of a well-balanced connector. However, in the case of an ill-balanced connector such as a D-SUB connector the contact side of which is shortened to save space, the force holding the connector is not sufficient. A structure of a fixation metal fitting having larger holding force is required.

### SUMMARY

According to an aspect of the invention, a connector fixation metal fitting includes an attachment portion to be attached to a body of a connector, and an insertion piece to be inserted into an attachment hole formed in a board on which the connector is mounted. The insertion piece includes two elastic pieces. The two elastic pieces are coupled together at their ends in the insertion direction of the insertion piece into the board and extend from the coupled portions in a direction opposite to the insertion direction so as to form free ends. The free ends are bent in opposite directions in the plate-thickness direction.

The object and advantages of the invention will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1A illustrates an example of attachment of a general D-SUB connector to a board, as viewed from the front.

FIG. 1B illustrates an example of attachment of a general D-SUB connector to a board, as viewed from the back.

FIG. 2 illustrates an example of structure of a general fixation metal fitting.

FIG. 3 illustrates an example of upward displacement of a temporarily fixed connector.

FIG. 4 illustrates an example of structure of a fixation metal fitting in a first embodiment.

FIG. 5A illustrates an example of a fixation metal fitting attached to a connector in a first embodiment.

FIG. 5B illustrates an example of temporary fixation of a connector to a board in a first embodiment.

FIG. 6 illustrates a modification of elastic pieces at the time of temporary fixation in a first embodiment.

FIG. 7A illustrates an example of structure of a fixation metal fitting in a second embodiment.

FIG. 7B illustrates an example of temporary fixation of a connector to a board in a second embodiment.

FIG. 8A illustrates an example of structure of a fixation metal fitting in a third embodiment.

FIG. 8B illustrates an example of temporary fixation of a connector to a board in a third embodiment.

### DESCRIPTION OF EMBODIMENTS

Before describing embodiments, an example of upward displacement of a connector will be described in which during temporary fixation before a connector mounted on a board is soldered.

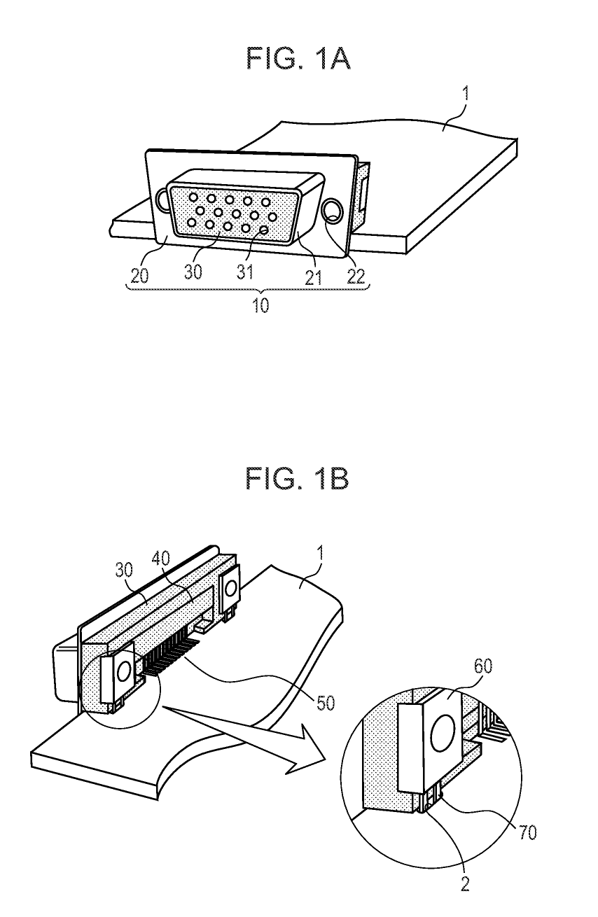

First, the general structure of a D-SUB connector and an example of attachment of a D-SUB connector to a board will be described. FIGS. 1A and 1B illustrate an example of attachment of a D-SUB connector that is a VGA connector to a board of a notebook PC. A connector 10 is attached to an end of a board 1 in order to connect to a display that is an external device of the notebook PC. FIG. 1A is a view from the front into which a plug connector is inserted. FIG. 1B is a view from the back of FIG. 1A. In FIG. 1A, the front of the connector 10 is covered by a metal shell 20, and part thereof has a fitting portion 21 that protrudes forward and into which a plug connector is fitted. In the fitting portion 21, a part of the housing 30 is exposed. In the exposed part of the housing 30, pin holes 31 are formed into which pins (here 15 pins) of a plug connector are inserted. Two screw holes 22 formed in the metal shell 20 are the holes for fixing the plug connector to the connector 10.

FIG. 1B illustrates a state where fixation metal fittings 70 (the details will be described later) are inserted into attachment holes 2 of a board 1, and the connector 10 is temporarily fixed. The fixation metal fittings 70 are attached to the housing 30 by fixing members 60. From the housing 30, contact pins 50 extend onto a pad (not illustrated) formed on the board 1 (when the mounting is completed, the contact pins 50 are soldered to the pad). One ends of the contact pins 50 are connected to the pin holes 31 inside the housing 30. The parts of the contact pins 50 protruding from the pin holes 31 to the contact side are bent, and are pressed against and fixed to the housing 30 by a pressing plate 40.

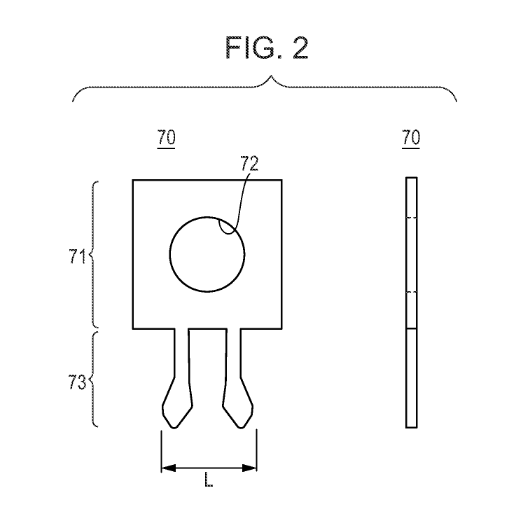

Next, an example of the structure of the fixation metal fittings 70 and an example of upward displacement of a connector temporarily fixed to a board 1 using the fixation metal fittings 70 will be described with reference to FIGS. 2 and 3.

FIG. 2 illustrates a general example of structure of a fixation metal fitting 70. The fixation metal fitting 70 includes an attachment portion 71 to be attached to the housing 30 illustrated in FIGS. 1A and 1B, and a pair of locking pieces 73 to be inserted into an attachment hole 2 of a board 1. The attachment portion 71 of the fixation metal fitting 70 is put between the housing 30 and the fixing member 60, and the fixation metal fitting 70 is fixed to the housing 30 by a screw screwed through a hole 72 formed substantially in the center of the attachment portion 71.

The distal ends of the locking pieces 73 have an outward-bulging shape, and the length L between the outer edges of the bulges is slightly larger than the length of the long axis of the oval attachment hole 2 formed in the board 1. When the locking pieces 73 are inserted into the attachment hole 2, the outward-bulging portions of the locking pieces 73 move along the inner walls in the long axis direction of the attachment hole 2, and press the inner walls owing to the elasticity of the locking pieces 73. The fixation metal fitting 70 is formed of a plate-like spring material.

However, when a space-saving D-SUB connector the fitting portion of which is covered by a metal shell as described above, is temporarily fixed to an end of a board, sometimes the connector inclines and is displaced upward from the board owing to vibration or the like during temporary fixation because of imbalance. FIG. 3 illustrates such an example, the left portion illustrates a sectional side view of the connector 10, and the right portion illustrates a sectional back view of the connector 10. As illustrated in the left portion of FIG. 3, the connector 10 is inclined at an angle of about 5 degrees to the side where the fitting portion 21 is located (the left side in FIG. 3, fitting side), and the bottom of the housing 30 is out of contact with the board 1. The fitting portion 21 side of the connector 10 is covered by the metal shell and is therefore heavy, and the side where the contacts are located is short and lightweight owing to space-saving. Therefore, the connector 10 is ill-balanced. If there is a variation in the dimension of the attachment hole 2, the connector 10 is prone to such displacement. In particular, in the case of the method illustrated in FIG. 3 in which the locking pieces 70 press the inner wall in the long axis direction of the attachment hole 2, the pressing force does not act in the direction in which the connector 10 inclines, and therefore the connector 10 is prone to incline.

### First Embodiment

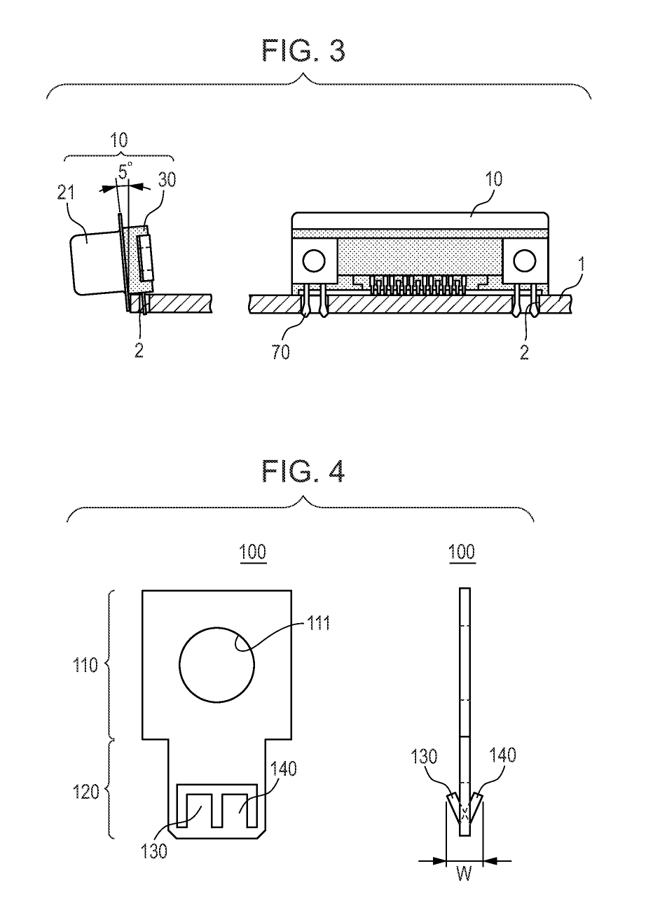

Next, an example of structure of a fixation metal fitting 100 of the present invention will be described. FIG. 4 illustrates the structure of a fixation metal fitting 100 of the present invention. The fixation metal fitting 100 includes an attachment portion 110 to be attached to a housing, and an insertion piece 120 to be inserted into an attachment hole of a board. The hole 111 formed substantially in the center of the attachment portion 110 is a hole for fixing the fixation metal fitting 100 to the housing with a screw, and is the same as the hole 72 illustrated in FIG. 2, so the description thereof will be omitted.

The insertion piece 120 is punched such that as illustrated in FIG. 4, two elastic pieces 130 and 140 are coupled together at their lower ends (at their ends in the direction in which the attachment portion 110 is inserted into the board), and the upper ends thereof are free ends. The free upper end of the elastic piece 130 and the free upper end of the elastic piece 140 are bent in opposite directions in the plate-thickness direction. The width W between the upper ends of the elastic pieces 130 and 140 is slightly larger than the length of the short axis of the oval attachment hole formed in the board. Here, the short axis of the attachment hole is 0.8 mm, and W of FIG. 4 is 1.05 mm. The length from the lower ends to the upper ends of the elastic pieces 130 and 140 is 6 mm. When inserted into the board, the upper ends of the elastic pieces 130 and 140 are located substantially in the center of the thickness of the board (at the position of half of the thickness). Since the lower ends of the elastic pieces 130 and 140 are coupled together, the lower ends can be smoothly inserted into the attachment hole of the board without being stuck on the inner wall of the attachment hole. In addition, since the upper ends are bent in opposite directions, the upper ends are stuck on the inner wall of the attachment hole, and therefore the fixation metal fitting 100 is less likely to come off from the attachment hole.

The fixation metal fitting 100 is formed of a phosphor-bronze plate 0.35 mm thick. As will be described later, when the elastic pieces 130 and 140 are inserted into the attachment hole, the inner walls in the short axis direction of the attachment hole are pressed by the elasticity of the elastic pieces 130 and 140, and therefore the fixation metal fitting 100 needs to be made of an elastic material. Therefore, the fixation metal fitting 100 may be made of not only phosphor bronze but also any other elastic material such as beryllium copper or stainless steel.

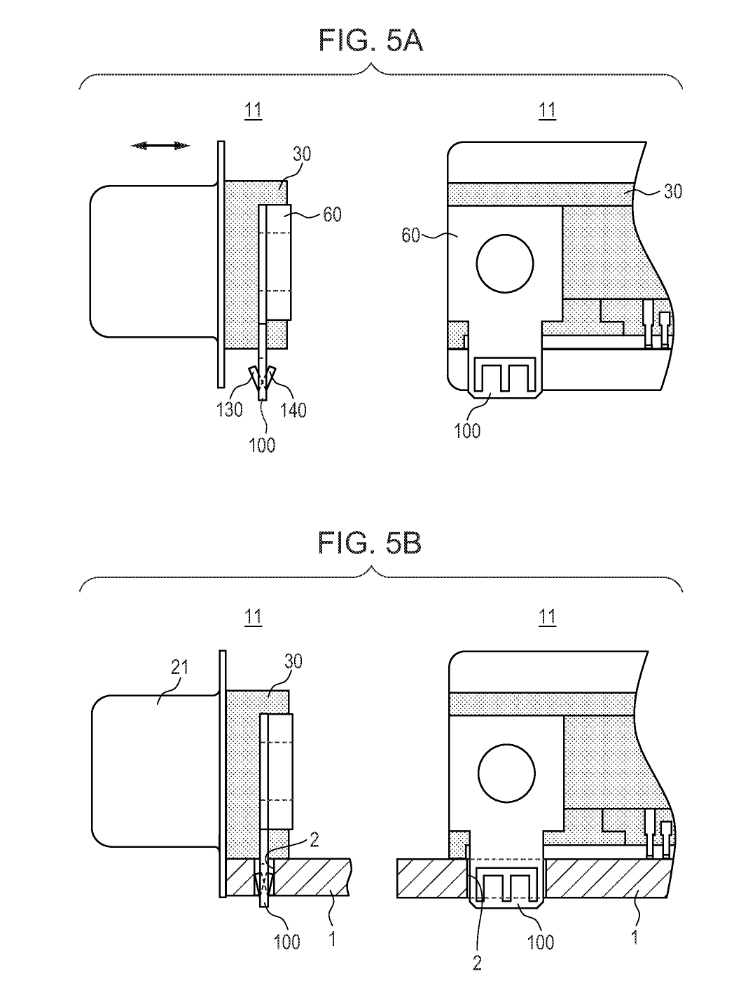

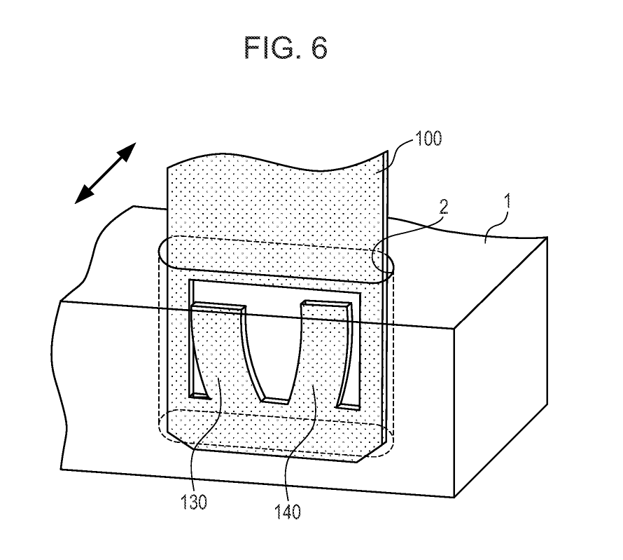

An example of a fixation metal fitting 100 attached to a connector (D-SUB connector) is illustrated in FIG. 5A. FIG. 5A illustrates a connector 11 to which a fixation metal fitting 100 is attached, as viewed from the side and back. As illustrated in FIG. 5A, the fixation metal fitting 100 is put between a housing 30 and a fixing member 60, and is fixed so as to protrude downward from the housing 30. The elastic pieces 130 and 140 of the fixation metal fitting 100 are bent in the direction in which a plug connector is inserted and extracted (the arrow in FIG. 5A illustrates the direction in which a plug connector is inserted and extracted).

FIG. 5B illustrates a state where the connector 11 of FIG. 5A is temporarily fixed to a board 1. With the insertion of the connector 11 into the attachment hole 2, the upper ends of the elastic pieces 130 and 140 of the fixation metal fitting 100 slide downward along the inner walls in the short axis direction of the attachment hole 2. When the bottom surface of the housing 30 reaches the upper surface of the board 1, the insertion of the connector 11 into the attachment hole 2 is stopped. FIG. 5B illustrates a state where the insertion of the fixation metal fitting 100 is stopped, that is to say, a state where the elastic pieces 130 and 140 are located at temporary fixation positions. The elastic pieces 130 and 140 in this state are illustrated in more detail in FIG. 6. The elastic pieces 130 and 140 inserted into the oval attachment hole 2 formed in the board 1 are curved as illustrated in FIG. 6 and pressing the inner walls of the attachment hole 2. The inner walls that the elastic pieces 130 and 140 are pressing are those in the short axis direction of the oval, which is the direction illustrated by the arrow in which a plug connector is inserted and extracted. Therefore, when the connector 11 inclines to the fitting side (to the left in FIG. 6), the elastic piece 130 elastically presses the inner wall in the short axis direction, and suppresses the inclination of the connector 11. At the same time, an upwardly pulling force acts on the upper end of the elastic piece 140. In that case, the edge of the upper end is stuck on the inner wall, and this resistance force suppresses the inclination of the connector 11.

### Second Embodiment

In the first embodiment, the two elastic pieces of the fixation metal fitting are the same in length. In a second embodiment, one of the elastic pieces is shorter than the other elastic piece so that the inclination of the connector toward the fitting side is further suppressed.

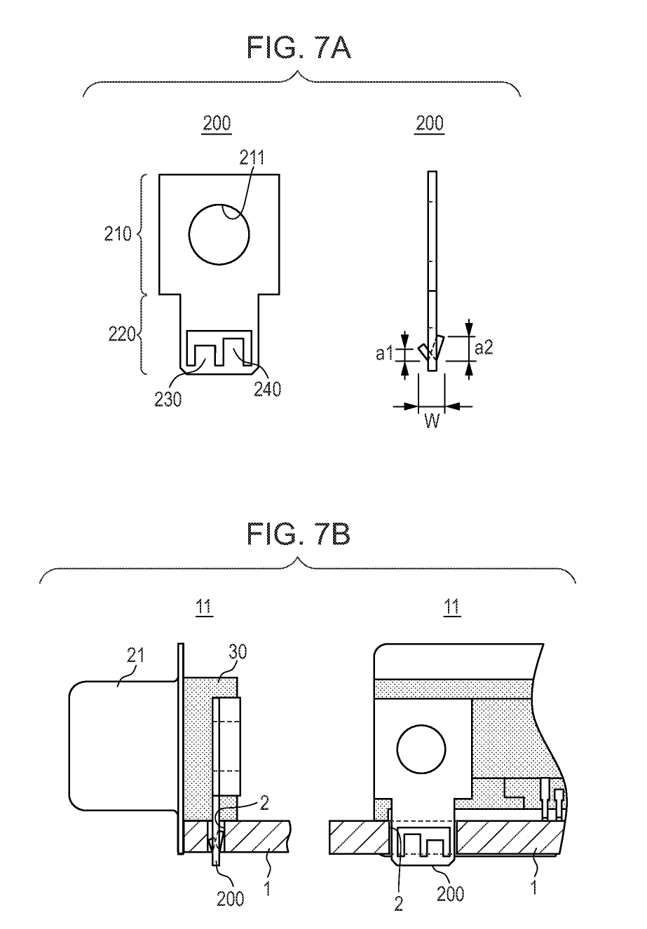

FIG. 7A and FIG. 7B illustrate an example of a fixation metal fitting in the second embodiment and an example of temporary fixation to a board. FIG. 7A illustrates the structure of a fixation metal fitting 200. As with the fixation metal fitting 100, the fixation metal fitting 200 includes an attachment portion 210 to be attached to a housing, and an insertion piece 220 to be inserted into an attachment hole of a board. The hole 211 formed substantially in the center of the attachment portion 210 is the same as the hole 111 of the fixation metal fitting 100, so the description thereof will be omitted.

The insertion piece 220 is punched such that as with the elastic pieces 130 and 140 of the fixation metal fitting 100, two elastic pieces 230 and 240 are coupled together at their lower ends and the upper ends thereof are free ends. As with the elastic pieces 130 and 140 of the fixation metal fitting 100, the upper end of the elastic piece 230 and the upper end of the elastic piece 240 are bent in opposite directions in the plate-thickness direction. The fixation metal fitting 200 differs from the fixation metal fitting 100 in the length of the elastic pieces (the length from the lower end to the upper end of the elastic pieces). Here, the elastic piece 230 is short compared to the elastic piece 240. Specifically, the length a1 of the elastic piece 230 illustrated in FIG. 7A is 4.5 mm, and the length a2 of the elastic piece 240 illustrated in FIG. 7A is 6 mm. The distance of the upper end of the elastic piece 230 from the center of plate thickness is equal to the distance of the upper end of the elastic piece 240 from the center of plate thickness. Therefore, the bending angle of the elastic piece 230 is larger than the bending angle of the elastic piece 240. The distance W between the upper ends of the elastic pieces is the same as that of the fixation metal fitting 100.

FIG. 7B illustrates an example of temporary fixation of a connector 11 to which the fixation metal fitting 200 is attached, to a board 1. The fixation metal fitting 200 is attached such that the shorter elastic piece 230 is located on the side where the fitting portion 21 is located. The elastic pieces 230 and 240 inserted into the attachment hole 2 press the inner walls in the short axis direction of the attachment hole 2 as with the fixation metal fitting 100. When the connector 11 inclines to the fitting side (to the left in the left portion of FIG. 7B), the resistance force is large compared to the first embodiment since the elastic piece 230 is short and the force of the elastic piece 230 pressing the inner wall is strong. That is to say, reducing the length of the elastic piece 230 on the side to which the connector 11 inclines, increases the spring pressure and further suppresses the inclination.

### Third Embodiment

In the second embodiment, a larger holding force of temporary fixation is obtained by shortening one of two elastic pieces. In a third embodiment, the same advantageous effect is obtained by increasing the width of one of two elastic pieces.

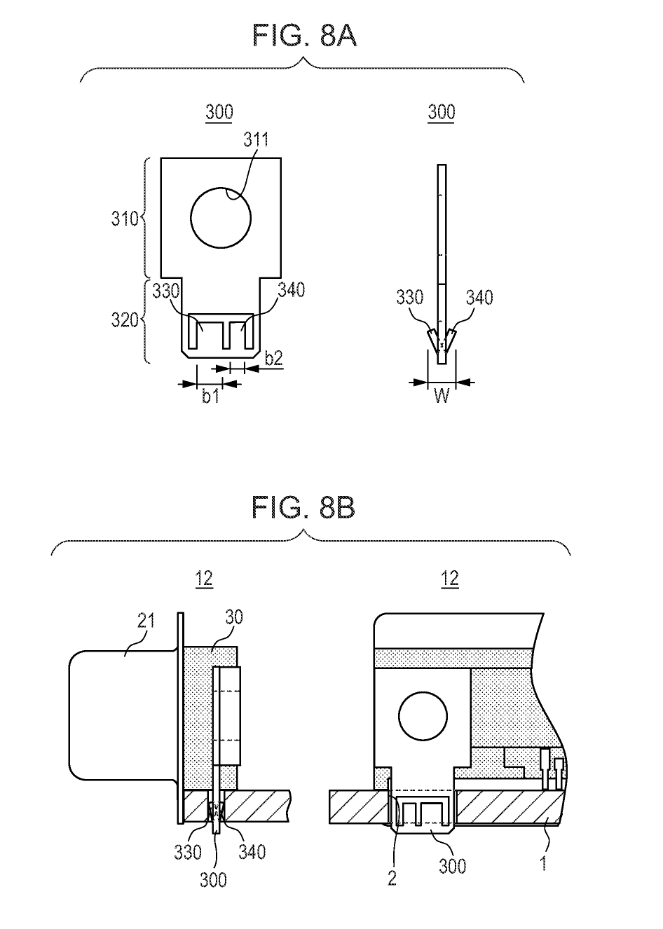

FIG. 8A and FIG. 8B illustrate an example of a fixation metal fitting in the third embodiment and an example of temporary fixation to a board. FIG. 8A illustrates the structure of a fixation metal fitting 300. As with the fixation metal fitting 200, the fixation metal fitting 300 includes an attachment portion 310 to be attached to a housing, and an insertion piece 320 to be inserted into an attachment hole of a board. The hole 311 formed substantially in the center of the attachment portion 310 is the same as the hole 111 of the fixation metal fitting 100, so the description thereof will be omitted.

As with the fixation metal fitting 100 and the fixation metal fitting 200, two elastic pieces 330 and 340 of the insertion piece 320 are coupled together at their lower ends, the upper ends thereof are free ends, and the upper ends of the elastic pieces are bent in opposite directions in the plate-thickness direction. The fixation metal fitting 300 differs from the fixation metal fitting 100 in the width of the elastic pieces. Here, the elastic piece 330 is wide compared to the elastic piece 340. The width b1 of the elastic piece 330 illustrated in FIG. 8A is 5.28 mm, and the width b2 of the elastic piece 340 illustrated in FIG. 8A is 3.08 mm. The distance W between the upper ends of the elastic pieces is the same as that of the fixation metal fitting 100.

FIG. 8B illustrates an example of temporary fixation of a connector 12 to which the fixation metal fitting 300 is attached, to a board 1. The fixation metal fitting 300 is attached such that the wider elastic piece 330 is located on the side where the fitting portion 21 is located. As with the fixation metal fitting 200, the elastic pieces 330 and 340 inserted into the attachment hole 2 press the inner walls in the short axis direction of the attachment hole 2. When the connector 12 inclines to the fitting side (to the left in the left portion of FIG. 8B), the resistance force is large since the spring force of the wider elastic piece 330 is stronger than that of the elastic piece 340. That is to say, increasing the width of the elastic piece 330 on the side to which the connector 12 inclines, increases the spring pressure and further suppresses the inclination.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A connector fixation metal fitting comprising:
an attachment portion configured to be attached to a body of a connector; and
an insertion piece configured to be inserted into an attachment hole formed in a board on which the connector is mounted,
wherein the insertion piece includes two elastic pieces,
the two elastic pieces are coupled together at their ends in the insertion direction of the insertion piece into the board and extend from the coupled portions in a direction opposite to the insertion direction so as to form free ends, and
the free ends are bent in opposite directions in the plate-thickness direction.

2. The connector fixation metal fitting according to claim 1, wherein the length from the coupled portion to the free end of one of the two elastic pieces is shorter than that of the other elastic piece.

3. The connector fixation metal fitting according to claim 1, wherein the width in the plate width direction of one of the two elastic pieces is wider than that of the other elastic piece.

4. A receptacle type connector to be mounted on a board, the connector comprising:
a housing; and
a fixation metal fitting fixed to the housing and to be inserted into an attachment hole formed in the board,
wherein the fixation metal fitting has two elastic pieces formed in an insertion piece to be inserted into the attachment hole,
the two elastic pieces are coupled together at their ends in the insertion direction of the insertion piece into the board and extend from the coupled portions in a direction opposite to the insertion direction so as to form free ends,
the free end of one of the two elastic pieces is bent in the insertion direction of a plug connector, and
the free end of the other elastic piece is bent in the extraction direction of the plug connector.

5. The connector according to claim 4, wherein the length from the coupled portion to the free end of the elastic piece whose free end is bent in the extraction direction of the plug connector is shorter than that of the elastic piece whose free end is bent in the insertion direction of the plug connector.

6. The connector according to claim 4, wherein the width in the plate width direction of the elastic piece whose free end is bent in the extraction direction of the plug connector is wider than that of the elastic piece whose free end is bent in the insertion direction of the plug connector.
